(19) United States
(12) Patent Application Publication
(10) Pub. No.: US 2014/0062961 A1
(43) Pub. Date: Mar. 6, 2014

(54) OPTICAL TOUCH CONTROL APPARATUS AND BRIGHTNESS ADJUSTING APPARATUS

(71) Applicant: PIXART IMAGING INC., Hsin-Chu City (TW)

(72) Inventors: Ming-Tsan Kao, Hsin-Chu City (TW); En-Feng Hsu, Hsin-Chu City (TW); Tien-Chia Liu, Hsin-Chu City (TW); Hsin-Chia Chen, Hsin-Chu City (TW)

(73) Assignee: PIXART IMAGING INC., Hsin-Chu City (TW)

(21) Appl. No.: 13/771,090

(22) Filed: Feb. 20, 2013

(30) Foreign Application Priority Data
Sep. 3, 2012 (TW) 101132039

(51) Int. Cl. G06F 3/042; H05B 37/02

(52) U.S. Cl. CPC G06F 3/042; H05B 37/02
USPC 345/175; 315/151

(57) ABSTRACT

An optical touch control apparatus, which comprises: a light source; a light guiding board, for emitting the light, including at least one reflecting region for generating reflected light for adjusting; a detecting surface, for generating an object image when a distance between a object and the detecting surface is lower than a predetermined distance; an image sensor, for computing a brightness for adjusting that the light source generates to the light guiding board according to the reflected light for adjusting, and for catching a plurality of frames of the object image; and a control unit, for adjusting the light source according to the brightness for adjusting, or for adjusting the image sensor according to the brightness for adjusting, such that the image sensor can sense a plurality of adjusted frames; wherein the control unit computes a location of the object on the detecting surface according to the adjusted frames.

### BACKGROUND OF THE INVENTION

1. Field of the Invention

The present invention relates to an optical touch control apparatus and a brightness adjusting apparatus, and particularly relates to an optical touch control apparatus and a brightness adjusting apparatus, which utilize light reflected from a light guiding board to adjust a light source.

2. Description of the Prior Art

FIG. 1 is a schematic diagram illustrating s prior art optical touch control apparatus 100. As shown in FIG. 1, the optical touch control apparatus 100 includes a detecting surface 101, alight source 103 and an image sensor 105. The light source 103 emits light to a finger F above the detecting surface 101. Also, the image sensor 105 detects an image of the finger F according to reflected light from the finger F, and accordingly computes location information or moving tracks of the finger F on the detecting surface 101 for touch control.

However, the brightness generated by the light source 103 may be not constant as desired. For example, the brightness generated by the light source 103 may decade due to the increasing for usage time, thus the light source 103 may generate brightness lower than expected, even it is given the same driving currents or driving voltage. Therefore, some errors may occur for the sensing operation for the image sensor 105 due to unexpected brightness. However, a prior art optical touch control apparatus does not have a real time mechanism for detecting and adjusting the brightness of the light source.

### SUMMARY OF THE INVENTION

Therefore, one objective of the present invention is to provide an optical touch control apparatus that can adjust the brightness in real time.

Additionally, another objective of the present invention is to provide a brightness adjusting apparatus that can adjust the brightness in real time.

One embodiment of the present invention provides an optical touch control apparatus, which comprises: a light source; a light guiding board, for receiving light from the light source and for emitting the light, wherein the light guiding board includes at least one reflecting region, for reflecting the light from the light source to generate reflected light for adjusting; a detecting surface, for generating an object image when a distance between a object and the detecting surface is lower than a predetermined distance; an image sensor, for computing a brightness for adjusting that the light source generates to the light guiding board according to the reflected light for adjusting, and for catching a plurality of frames of the object image; and a control unit, for adjusting the light source according to the brightness for adjusting such that the light source generates a predetermined brightness, or for adjusting the image sensor according to the brightness for adjusting such that the image sensor senses the predetermined brightness, such that the image sensor can sense a plurality of adjusted frames; wherein the control unit computes a location of the object on the detecting surface according to the adjusted frames.

One embodiment of the present invention provides a brightness adjusting apparatus, comprising: alight source; a light guiding board, for receiving light from the light source and for emitting the light, wherein the light guiding board includes at least one reflecting region, for reflecting the light from the light source to generate reflected light for adjusting; a brightness sensor, for computing a brightness for adjusting that the light source generates to the light guiding board according to the reflected light for adjusting; and a control unit, for adjusting the light source according to the brightness for adjusting such that the light source generates a predetermined brightness, or for adjusting the brightness sensor according to the brightness for adjusting such that the brightness sensor senses the predetermined brightness.

In view of above-mentioned embodiments, the brightness of the light from the light source or the brightness sensed by the image sensor can be adjusted in real time, such that the brightness can be remained for constant such that the location or the moving tracks of the object can be correctly detected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating s prior art optical touch control apparatus.

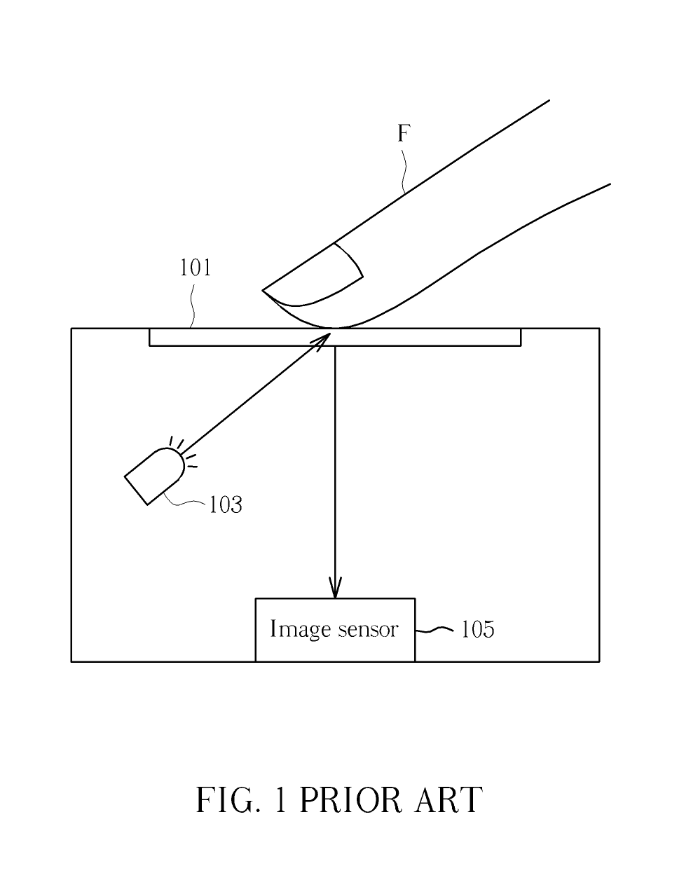

FIG. 2 is a side view illustrating an optical touch control apparatus according to one embodiment of the present invention.

FIG. 3 is a top view illustrating an optical touch control apparatus according to one embodiment of the present invention.

FIG. 4 is a flow chart illustrating brightness adjusting operation for the optical touch control apparatus shown in FIG. 2.

FIG. 5 is a flow chart illustrating that the optical touch control apparatus shown in FIG. 2 utilizes adjusted brightness to perform optical touch control.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

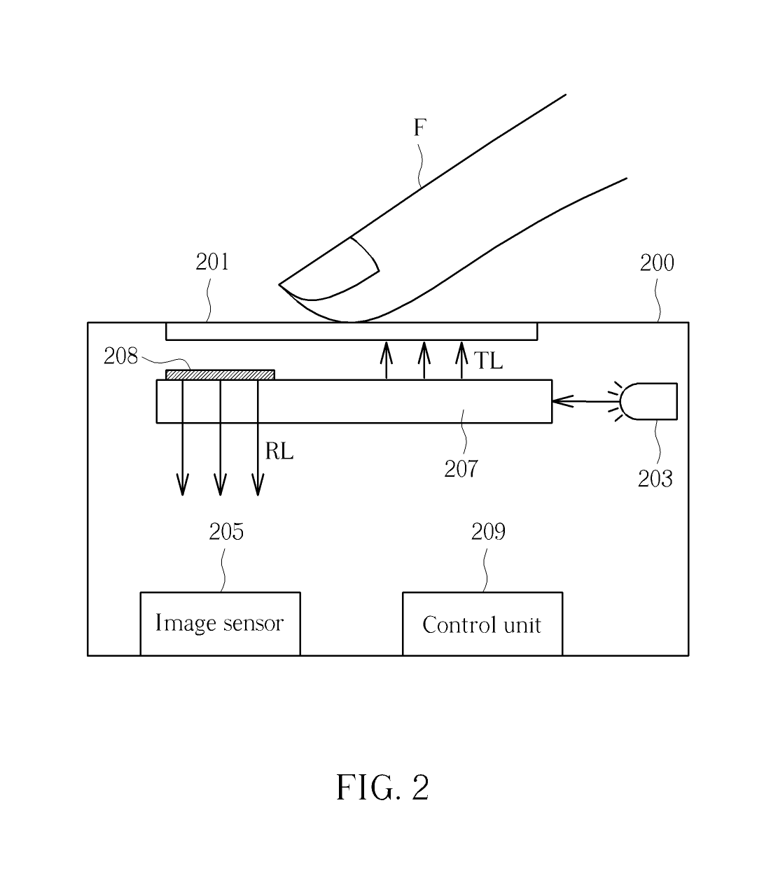

FIG. 2 is a side view illustrating an optical touch control apparatus according to one embodiment of the present invention. As shown in FIG. 2, the optical touch control apparatus 200 includes a detecting surface 201, a light source 203, an image sensor 205, a light guiding board 207 and a control unit 209. The light guiding board 207 comprises a reflecting region 208. The light guiding board 207 receives light from the light source 203 and emits the light TL to the detecting surface 201. The reflecting region 208 reflects the light from the light source 203 to generate reflected light for adjusting RL. The reflecting region 208 can be formed via coating reflecting material with a specific reflecting rate to the light guiding board, or be formed via providing a reflecting cloth on the light guiding board.

An object image of the object is generated according light TL from the light guiding board 207, when a distance between an object such as a finger F and the detecting surface 201 is lower than a predetermined distance (that is, the object floats above the detecting surface 201 or touches the detecting surface 201). The image sensor 209 computes a real brightness (called brightness for adjusting hereafter) that the light source 203 generates to the light guiding board 207 according to the reflected light for adjusting RL, and can catch a plurality of frames of the object image. The control unit 209 adjusts the light source 203 according to the brightness for adjusting such that the light source 203 generates a predetermined brightness. Alternatively, the control unit 209 can adjust the image sensor 205 according to the brightness for adjusting such that the image sensor 205 senses the predetermined brightness to reach the same function. Additionally, the control unit 209 computes a location for the object on the detecting surface 201 according to caught frames. Please note that if the control unit 209 only computes and adjusts brightness but does not catch frames, the optical touch control apparatus 200 can be regarded as a brightness adjusting apparatus, and the image sensor can be regarded as a brightness sensor. The detail operations thereof will be shown as below.

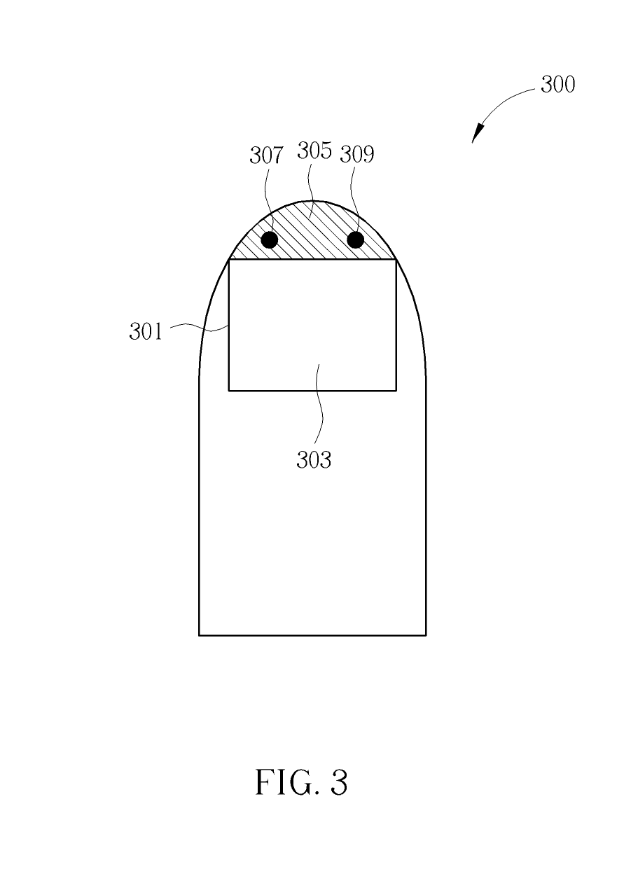

FIG. 3 is a top view illustrating an optical touch control apparatus according to one embodiment of the present invention. As shown in FIG. 3, the optical touch control 300 includes a detecting surface 301, which includes a touch control region 303 and a non touch control region 305. The touch control region 303 indicates a region that an object often moves thereon such that the touch control function can be performed. Oppositely, the non touch control region 305 indicates the object seldom moves thereon. Therefore, the touch control region can be defined as: a frequency that the object touches the touch control region is larger than the regions outside the touch control region. Alternatively, in other embodiments, the touch control function can only be performed by the touch control region 303, and can not be performed by regions outside the touch control region (such as the non touch control region 305). In other words, the detecting surface 301 can detect a location of the object on the detecting surface 301 only by the touch control region 303. Locations of the reflecting regions 307, 309 are determined by the non touch control region 305, that is, locations of the reflecting regions 307, 309 correspond to which of the non touch control region 305. For example, the locations of the reflecting regions 307, 309 are under the non touch control region 305 in this embodiment, but it is not limited.

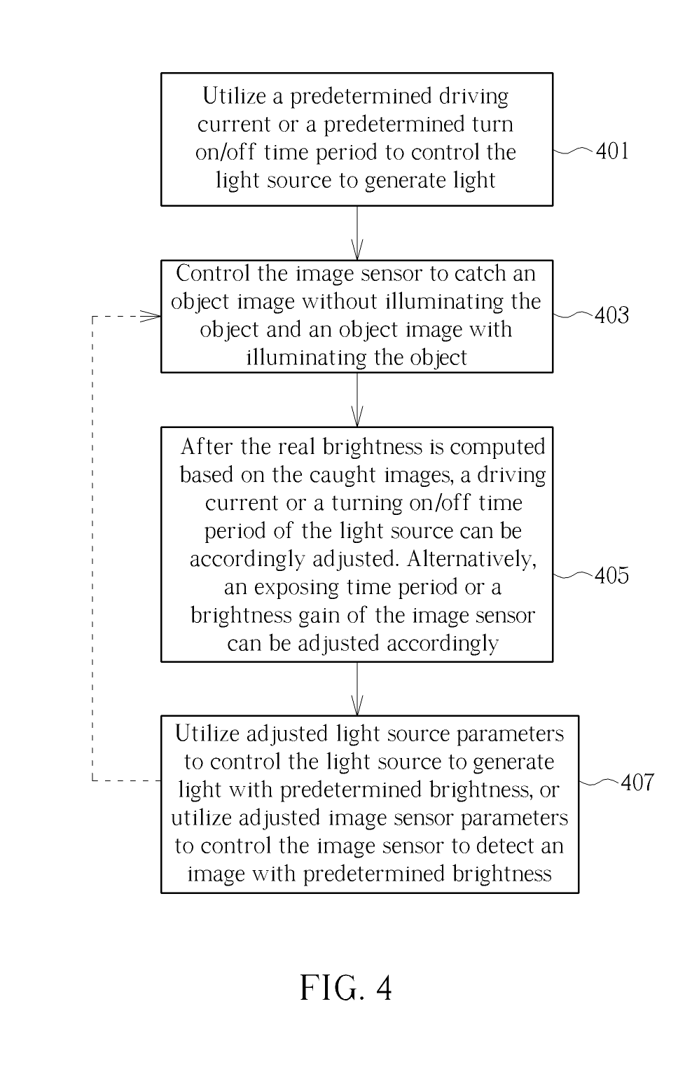

FIG. 4 is a flow chart illustrating adjusting operation for the optical touch control apparatus shown in FIG. 2. Please refer to both FIG. 2 and FIG. 4 to understand the concept of the present invention for more clear. FIG. 4 includes the following steps:

Step 401

Utilize a predetermined driving current or a predetermined turn on/off time period to control the light source to generate light (i.e. generate real brightness).

Step 403

Control the image sensor to catch an object image without illumination and an object with illumination. Please note the purpose of the step 403 is to catch two different types of images such that the real brightness can be computed. However, the method for acquiring the real brightness is not limited to such step, other methods that can compute the real brightness also fall in the scope of the present invention.

Step 405

After the real brightness is computed based on the caught images, a driving current or a turning on/off time period of the light source can be accordingly adjusted (i.e. adjust the light source generate a predetermined brightness according to the brightness for adjusting). Alternatively, an exposing time period or a brightness gain of the image sensor can be adjusted accordingly (i.e. adjust the image sensor according to the brightness for adjusting such that the image sensor senses the predetermined brightness). Information about the predetermined brightness can be pre-stored in the optical touch control apparatus.

Step 407

Utilize adjusted light source parameters to control the light source to generate light with predetermined brightness, or utilize adjusted image sensor parameters to control the image sensor to detect an image with predetermined brightness. After the step 407, the brightness operation can end, or go back to the step 403 to repeat steps for brightness adjusting.

The brightness adjusting mechanism can be triggered by an user via software or via a switch on the brightness adjusting apparatus. Additionally, the optical touch control apparatus 200 can automatically trigger brightness adjusting mechanism periodically, or non periodically.

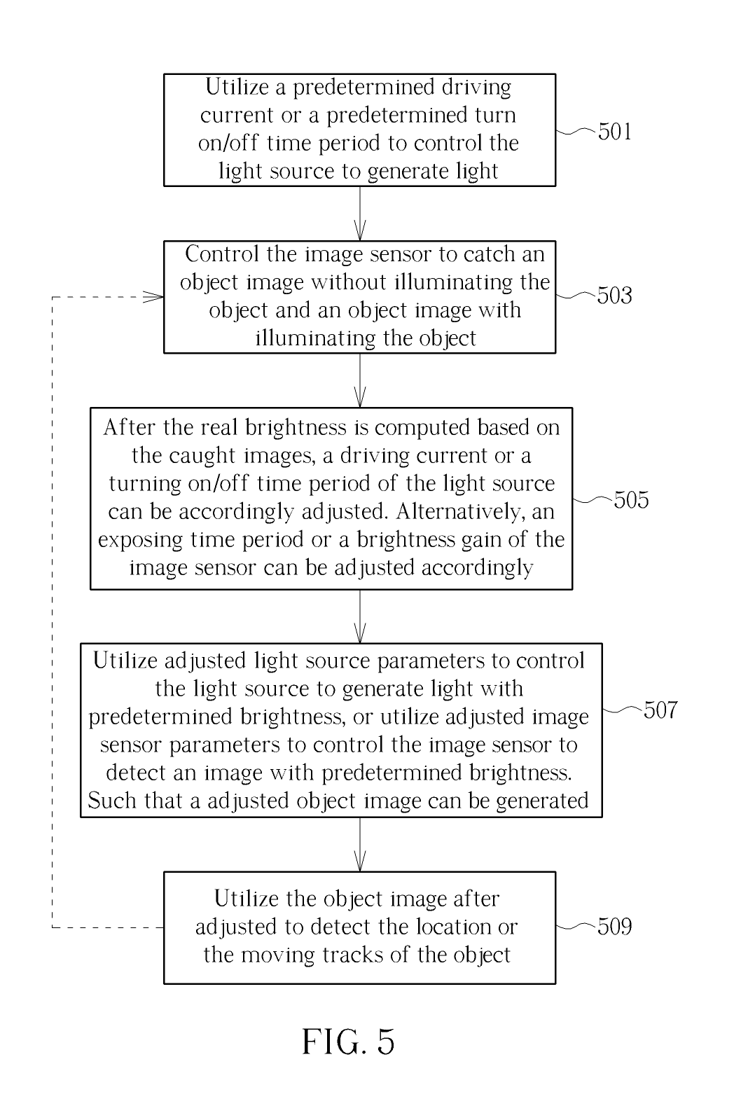

FIG. 5 is a flow chart illustrating that the optical touch control apparatus shown in FIG. 2 utilizes adjusted brightness to perform optical touch control.

Step 501

Utilize a predetermined driving current or a predetermined turn on/off time period to control the light source to generate light (i.e. generate real brightness).

Step 503

Control the image sensor to catch an object image without illumination and an object with illumination. As above-mentioned in the step 403, the purpose of the step 503 is to catch two different types of images such that the real brightness can be computed, but other methods that can compute the real brightness also fall in the scope of the present invention.

Step 505

After the real brightness is computed based on the caught images, a driving current or a turning on/off time period of the light source can be accordingly adjusted (i.e. adjust the light source generate a predetermined brightness according to the brightness for adjusting). Alternatively, an exposing time period or a brightness gain of the image sensor can be adjusted accordingly (i.e. adjust the image sensor according to the brightness for adjusting such that the image sensor senses the predetermined brightness). Information about the predetermined brightness can be pre-stored in the optical touch control apparatus.

Step 507

Utilize adjusted light source parameters to control the light source to generate light with predetermined brightness, or utilize adjusted image sensor parameters to control the image sensor to detect an image with predetermined brightness. Such that a adjusted object image can be generated (including a plurality of adjusted frames).

Step 509

Utilize the image after adjusted to detect the location or the moving tracks of the object.

In view of above-mentioned embodiments, the brightness of the light from the light source or the brightness sensed by the image sensor can be adjusted in real time, such that the brightness can be remained for constant such that the location or the moving tracks of the object can be correctly detected.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical touch control apparatus, comprising:
a light source;
a light guiding board, for receiving light from the light source and for emitting the light, wherein the light guiding board includes at least one reflecting region, for reflecting the light from the light source to generate reflected light for adjusting;
a detecting surface, for generating an object image when a distance between a object and the detecting surface is lower than a predetermined distance;
an image sensor, for computing a brightness for adjusting that the light source generates to the light guiding board according to the reflected light for adjusting, and for catching a plurality of frames of the object image; and
a control unit, for adjusting the light source according to the brightness for adjusting such that the light source generates a predetermined brightness, or for adjusting the image sensor according to the brightness for adjusting such that the image sensor senses the predetermined brightness, such that the image sensor can sense a plurality of adjusted frames;
wherein the control unit computes a location of the object on the detecting surface according to the adjusted frames.

2. The optical touch control apparatus of claim 1, further comprising:
reflecting material with a specific reflecting rate, which is coated on a part of the light guiding board to form the reflecting region.

3. The optical touch control apparatus of claim 1, further comprising:
a reflecting cloth, covering a part of the light guiding board to form the reflecting region.

4. The optical touch control apparatus of claim 1, wherein the detecting surface includes a touch control region; where the detecting surface can detect a location of the object on the detecting surface only by the touch control region; wherein the reflecting region of the light guiding board corresponds regions outside the touch control region.

5. The optical touch control apparatus of claim 1, wherein the detecting surface includes a touch control region; where the reflecting region of the light guiding board corresponds regions outside the touch control region; wherein a frequency that the object touches the touch control region is larger than the regions outside the touch control region.

6. The optical touch control apparatus of claim 1, wherein the control unit utilizes the light source after adjusted or the image sensor after adjusted to compute the location of the object on the detecting surface, after adjusting the light source according to the brightness for adjusting, or after adjusting the image sensor according to the brightness for adjusting.

7. The optical touch control apparatus of claim 1, wherein the control unit adjusts a driving current of the light source or a turning on/off time period of the light source, according to the brightness for adjusting.

8. The optical touch control apparatus of claim 1, wherein the control unit adjusts an exposing time period or a brightness gain of the image sensor, according to the brightness for adjusting.

9. A brightness adjusting apparatus, comprising:
a light source;
a light guiding board, for receiving light from the light source and for emitting the light, wherein the light guiding board includes at least one reflecting region, for reflecting the light from the light source to generate reflected light for adjusting;
a brightness sensor, for computing a brightness for adjusting that the light source generates to the light guiding board according to the reflected light for adjusting; and
a control unit, for adjusting the light source according to the brightness for adjusting such that the light source generates a predetermined brightness, or for adjusting the brightness sensor according to the brightness for adjusting such that the brightness sensor senses the predetermined brightness.

10. The brightness adjusting apparatus of claim 9, further comprising:
reflecting material with a specific reflecting rate, which is coated on a part of the light guiding board to form the reflecting region.

11. The brightness adjusting apparatus of claim 9, further comprising:
a reflecting cloth, covering a part of the light guiding board to form the reflecting region.

12. The brightness adjusting apparatus of claim 9, wherein the control unit adjusts a driving current of the light source or a turning on/off time period of the light source, according to the brightness for adjusting.

13. The brightness adjusting apparatus of claim 9, wherein the control unit adjusts a exposing time period or a brightness gain of the brightness sensor, according to the brightness for adjusting.
